(19) United States
(12) Patent Application Publication
(10) Pub. No.: US 2016/0315582 A1
(43) Pub. Date: Oct. 27, 2016

(54) METHOD AND APPARATUS FOR MODIFYING IMAGE TO INCREASE SOLAR ENERGY COLLECTION EFFICIENCY

(71) Applicant: Nokia Technologies Oy, Espoo (FI)

(72) Inventors: Zhigang CHEN, Beijing (CN); Li LUO, Beijing (CN); Chang LIU, Beijing (CN); Lu LIU, Beijing (CN); Bin GAO, Beijing (CN)

(73) Assignee: Nokia Technologies Oy, Espoo (FI)

(21) Appl. No.: 15/104,168

(22) PCT Filed: Jan. 10, 2014
(86) PCT No.: PCT/CN2014/070453

§ 371 Date: Jun. 13, 2016

(51) Int. Cl. H02S 40/38; G06F 3/0487; G06T 11/60; H02J 7/35; H02S 10/40

(52) U.S. Cl. CPC H02S 40/38; H02J 7/35; H02S 10/40; G06T 11/60; G06F 3/0487

(57) ABSTRACT

A method, apparatus and computer program product are provided in order to improve the efficiency with which a mobile device collects solar energy. In the context of a method, an image is caused to be presented upon an at least partially reflective screen of a user interface. The method also includes determining that the user interface is exposed to light. In response to a determination that the user interface is exposed to light, the method modifies the image presented upon the at least partially reflective screen so as to reflect and to facilitate collection of a greater percentage of the light.

### TECHNOLOGICAL FILED

An example embodiment of the present invention relates generally to the collection of solar energy by a mobile device and, more particularly, to modifying an image presented by the mobile device in order to improve the solar energy collection efficiency.

### BACKGROUND

Mobile devices, such as mobile telephones, personal digital assistants (PDAs), watches having communication capabilities and the like, are widely utilized in everyday life. These mobile devices generally include a display for the presentment of content. While the display may be backlit in order to facilitate viewing of the display, particularly in relatively bright light conditions, some mobile devices are relatively low powered devices that depend upon rechargeable batteries in order to operate. Thus, a backlit display may consume an undesirably large amount of energy and, as such, be unsuitable for at least some mobile devices.

Mobile devices having reflective or semi-reflective displays consume less energy than backlit displays and therefore offer reduced battery consumption. However, mobile devices having reflective or semi-reflective displays still must be repeatedly recharged, which may prove inconvenient, such as in some instances in which a source of electrical power is unavailable.

Some mobile devices rely, at least partially, upon the collection of solar energy in order to recharge their batteries or otherwise provide power for operation. These mobile device may include a charging cell for collecting solar energy. While reliance upon solar energy is useful and may reduce the instances in which the mobile device must be electrically connected to a power supply, such as to an electrical outlet, the collection of solar energy may not be as efficient as desired. As such, upon exposure to sunlight, a mobile device may collect a portion of the solar energy and utilize the portion of solar energy that is collected to power the mobile device and/or to recharge the battery of the mobile device. However, other portions of the solar energy may not be collected and may be wasted from a solar energy collection perspective. At least partially as a result of the relative inefficiency of solar energy collection, mobile devices that utilize solar energy may still repeatedly have to be recharged by the connection of the mobile device to an electrical power supply in order to supplement the solar energy, thereby potentially inconveniencing the user of the mobile device.

In an effort to collect additional solar energy, some mobile terminals have included a charging cell that is wider and/or thicker. While a larger charging cell may collect additional solar energy, a larger charging cell may disadvantageously reduce screen transparency.

### BRIEF SUMMARY

A method, apparatus and computer program product are therefore provided in accordance with an example embodiment in order to improve the efficiency with which a mobile device collects solar energy. As such, the method, apparatus and computer program product of an example embodiment may permit the mobile device to operate with increased reliance upon solar energy, thereby reducing instances in which the mobile device must be electrically connected to a wall outlet or other electrical power supply in order to recharge the battery. Further, the method, apparatus and computer program product may facilitate more energy efficient operation of a mobile device as a result of the improved collection efficiency of the solar energy that impinges upon the mobile device.

In an example embodiment, a method is provided that includes causing an image to be presented upon an at least partially reflective screen of a user interface. The method also includes determining that the user interface is exposed to light and, in response to a determination that the user interface is exposed to light, modifying the image presented upon the at least partially reflective screen so as to reflect and to facilitate collection of a greater percentage of the light. The method of an example embodiment also includes collecting at least some of the light reflected from the at least partially reflective screen following modification.

The method may modify the image in various manners in order to reflect a greater percentage of the light. The method of an example embodiment may modify the image by changing a background of the image to be lighter in color than one or more characters of the image. For example, the method may change the background of the image to be white. In another example embodiment to which the image that is caused to be presented is a gray scale image, the method may modify the image by causing the gray scale image to be presented with a lighter overall tone. The screen may include a plurality of pixels. As such, the method may modify the image by causing a greater percentage of the pixels to be white. The method of an example embodiment may modify the image by causing the image to be modified so as to have increased stability.

In another example embodiment, an apparatus is provided that includes at least one processor and at least one memory including computer program code with the at least one memory and computer program code configured to, with the processor, cause the apparatus to at least cause an image to be presented upon an at least partially reflective screen of a user interface. The at least one memory and the computer program code are also configured to, with the processor, cause the apparatus of this example embodiment to determine that the user interface is exposed to light and, in response to a determination that the user interface is exposed to light, modify the image presented upon the at least partially reflective screen so as to reflect and to facilitate collection of a greater percentage of the light. The at least one memory and the computer program code may also be configured to, with the processor, cause the apparatus of an example embodiment to collect at least some of the light reflected from the at least partially reflective screen following modification.

The at least one memory and the computer program code may be configured to, with the processor, cause the apparatus of an example embodiment to modify the image by changing the background of the image to be lighter in color than one or more characters of the image, such as by changing the background of the image to be white. In an instance in which the image that is caused to be presented is a gray scale image, the at least one memory and the computer program code may be configured to, with the processor, cause the apparatus of an example embodiment to modify the image by causing the gray scale image to be presented with a lighter overall tone. In an embodiment in which the screen includes a plurality of pixels, the at least one memory and the computer program code may be configured to, with the processor, cause the apparatus to modify the image by causing a greater percentage of the pixels to be white. The at least one memory and the computer program code may be configured to, with the processor, cause the apparatus of an example embodiment to modify the image by causing the image to be modified so as to have increased stability.

In an embodiment in which the apparatus is embodied by a mobile terminal, the mobile terminal may include the screen and a plurality of photovoltaic cells that at least partially overlie the screen to collect at least some of the light reflected from the at least partially reflective screen following modification. In this example embodiment, the plurality of photovoltaic cells may include a plurality of double-sided photovoltaic cells.

In further example embodiment, a computer program product is provided that includes at least one non-transitory computer-readable storage medium having computer-executable program code portions stored therein with the computer-executable program code portions including program code instructions for causing an image to be presented upon an at least partially reflective screen of a user interface and for determining that the user interface is exposed to light. In response to a determination that the user interface is exposed to light, the computer-executable program code portions may include program code instructions for modifying the image presented upon the at least partially reflective screen so as to reflect and to facilitate collection of a greater percentage of the light.

The program code instructions for modifying the image may include program code instructions for changing a background of the image to be lighter in color than one or more characters of the image, such as by changing the background of the image to be white. In an instance in which the image that is caused to be presented is a gray scale image, the program code instruction for modifying the image may include program code instructions for causing the gray scale image to be presented with a lighter overall tone. In an embodiment in which the screen includes a plurality of pixels, the program code instructions for modifying the image may include program code instructions for causing a greater percentage of the pixels to be white. In another example embodiment, the program code instructions for modifying the image may include program code instructions for causing the image to be modified so as to have increased stability.

In yet another embodiment, an apparatus is provided that includes means for causing an image to be presented upon an at least partially reflective screen of a user interface. The apparatus of this example embodiment also includes means for determining that the user interface is exposed to light. In response to a determination that the user interface is exposed to light, the apparatus also includes means for modifying the image presented upon the at least partially reflective screens so as to reflect and to facilitate collection of a greater percentage of the light. Further, the apparatus of an example embodiment may include means for collecting at least some of the light reflected from the at least partially reflective screen following modification.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a perspective view of a mobile device that may be specifically configured in accordance with an example embodiment of the present invention;

FIG. 2 is an exploded perspective view of a portion of a user interface of a mobile device that may be specifically configured in accordance with an example embodiment of the present invention;

FIG. 3 is a block diagram of an apparatus that may be specifically configured in accordance with an example embodiment of the present invention;

FIG. 4 is a flowchart illustrating operations performed, such as by the apparatus of FIG. 3, in accordance with an example embodiment of the present invention;

FIG. 5 illustrates the modification of an image by changing the background of the image to be lighter in color than the characters of the image in accordance with an example embodiment of the present invention; and

FIG. 6 illustrates the modification of a gray-scale image so as to have a lighter overall tone in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

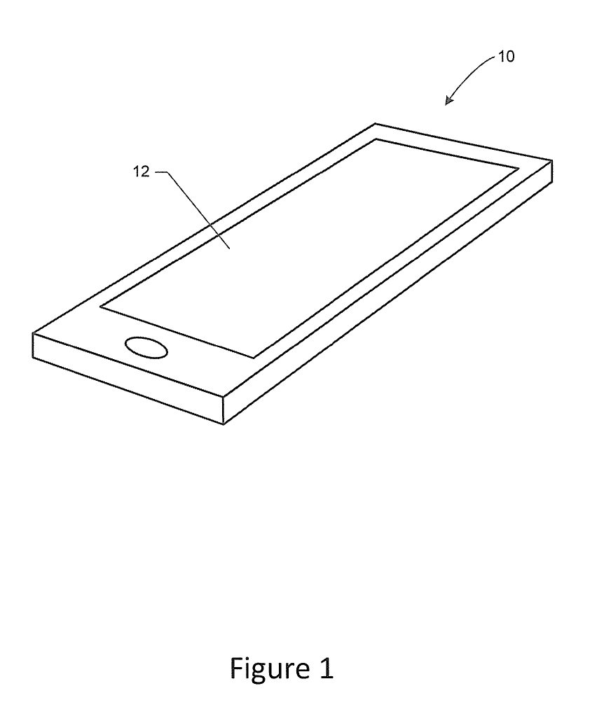

A method, apparatus and computer program product are provided in accordance with an example embodiment in order to improve the solar collection efficiency of a mobile device. The method, apparatus and computer program product may be employed in conjunction with a variety of different mobile or other battery powered devices (hereinafter generally referenced as “mobile devices”). For example, the mobile device may be a PDA, mobile telephone, smartphone, watch, E-ink display, E-paper display, pager, mobile television, gaming device, laptop computer, camera, tablet computer, touch surface, video recorder, audio/video player, radio, electronic book, positioning device (e.g., global positioning system (GPS) device), or any combination of the aforementioned, and other types of voice and text communications systems. By way of example, FIG. 1 depicts a mobile device 10 in the form of a mobile telephone, such as a smartphone. Among other features, the mobile device of FIG. 1 includes a display 12 that may be driven in order to present information to a user and, in some embodiments, may be embodied by a touch screen display so as to also receive user input.

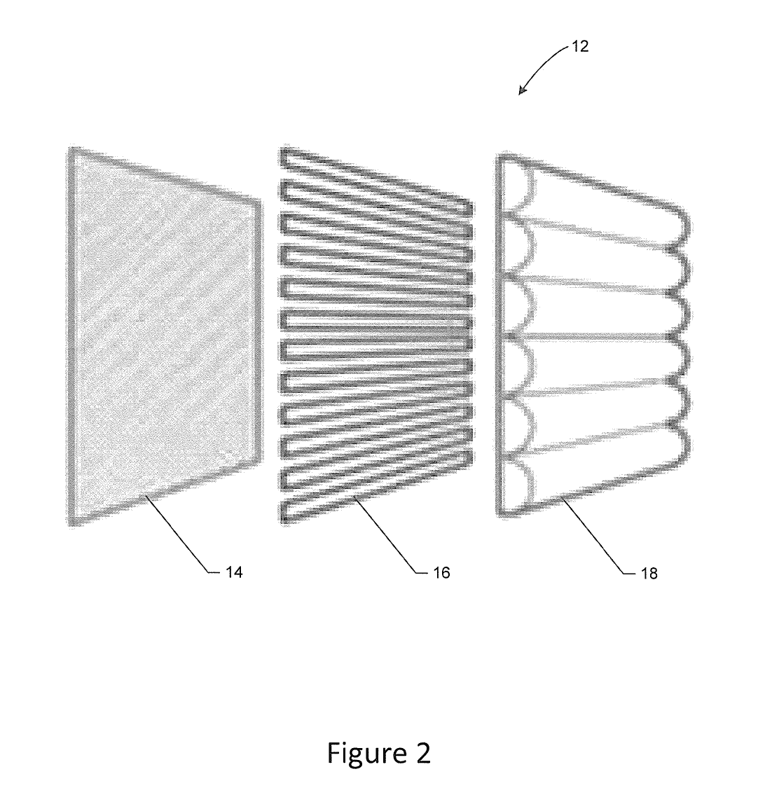

Referring now to FIG. 2, the display 12 in accordance with an example embodiment of the present invention is depicted. In this regard, the display includes a screen 14 upon which an image including the information to be provided to the user is presented. The screen is a reflective screen or a partially reflective screen, such as a half reflective screen, so as to at least partially reflect light incident thereupon.

The display 12 of this embodiment also includes at least one and, in an example embodiment, a plurality of solar cells 16 that at least partially overlie the screen 14. The solar cell(s) are configured to collect solar energy and to provide the energy, such as in a form of electrical current, to a charging circuit which, in turn, may recharge a battery of the mobile device 10. The solar cells may include a plurality of photovoltaic cells. In the illustrated embodiment, the photovoltaic cells extend horizontally across the screen with each photovoltaic cell spaced vertically from the adjacent photovoltaic cells. However, the photovoltaic cells may be oriented in other manners, such as vertically, diagonally or the like, relative to the screen. As noted above, the solar cells, such as the photovoltaic cells overlie at least a portion of the screen and in example embodiment, the solar cells, such as the photovoltaic cells, are transparent or at least partially transparent such that a user may view the portions of the screen that are overlaid by the solar cells through the solar cells.

The display 12 may also include one or more lenses 18, such as a plurality of hemicylindrical lenses. As shown in an example embodiment of FIG. 2, the plurality of hemicylindrical lenses may extend in the same direction that the plurality of solar cells 16 extend, such as horizontally from the left to the right across the screen 14. The lenses may be configured, such as in instances in which the plurality of solar cells are opaque, to spread the image presented upon the screen that is visible between the plurality of solar cells such that the user viewing the display will see a continuous image without any visual interruptions created by the solar cells. In the illustrated embodiment, the lenses overlie the solar cells such that the solar cells are disposed between the lenses and the screen. Alternatively, the solar cells may overlie the lenses such that the lenses are disposed between the solar cells and the screen.

Upon exposure to light, a portion of the light that impinges upon the display 12 is initially incident upon the solar cells 16 which, in turn, collect the solar energy for provision, such as in the form of electrical current, to a charging circuit. However, the remaining portion of the light that is incident upon the display passes between the solar cells and is incident upon the screen 14. Since the screen is reflective or at least partially reflective, at least a portion of the light that is incident upon the screen is reflected with at least some of the reflected light then impinging upon the solar cells, albeit the surface of the solar cells that faces the screen. To facilitate the collection of solar energy, the plurality of solar cells may be double sided solar cells so as to receive and collect solar energy that impinges upon the solar cells from either of the opposed surfaces, that is, the surface that faces the screen and the surface that faces away from the screen.

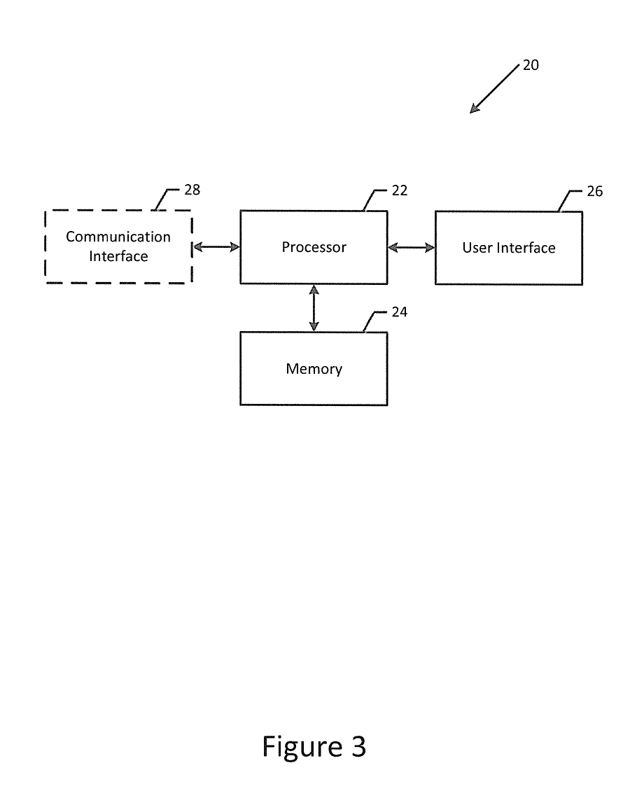

In accordance with an example embodiment, the method, apparatus and computer program product may modify the image presented upon the screen 14 so as to improve or increase the reflection of light therefrom. As such, the solar collection efficiency may be correspondingly improved. In order to provide for the modification of the image presented upon the at least partially reflective screen, an apparatus 20 may be provided and specifically configured as shown in FIG. 3. The apparatus may be embodied by or otherwise associated with the mobile device 10.

Regardless of the manner in which the apparatus 20 is instantiated, the apparatus is specifically configured to perform the operations to modify the image presented by an at least partially reflective screen 14 so as to improve the solar energy collection efficiency. As shown in FIG. 3, for example, the apparatus may include or otherwise be in communication with a processor 22, a memory device 24 and a user interface 26 and, in some embodiments, a communication interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a mobile device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., the mobile terminal 10) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 also includes a user interface 26 that may be in communication with the processor 22 to provide output to the user and, in some embodiments, to receive an indication of a user input. As such, the user interface may include an at least partially reflective screen 14 upon which an image is presented, as well as one or more solar cells 16 and one or more lenses 18 as shown in FIG. 2 and as described above. As also noted above, the at least partially reflective screen may, in some embodiments, be a touch screen for not only providing output, but for receiving user input. In some embodiments, the user interface may also include a keyboard, a mouse, a joystick, touch areas, soft keys, one or more microphones, a plurality of speakers, or other input/output mechanisms. In an example embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (e.g., software and/or firmware) stored on a memory accessible to the processor (e.g., memory device 24, and/or the like).

The apparatus 20 of the illustrated embodiment may also optionally include a communication interface 28 that may be any means such as a device or circuitry embodied in either hardware or a combination of hardware and software that is configured to receive and/or transmit data from/to a communications device in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

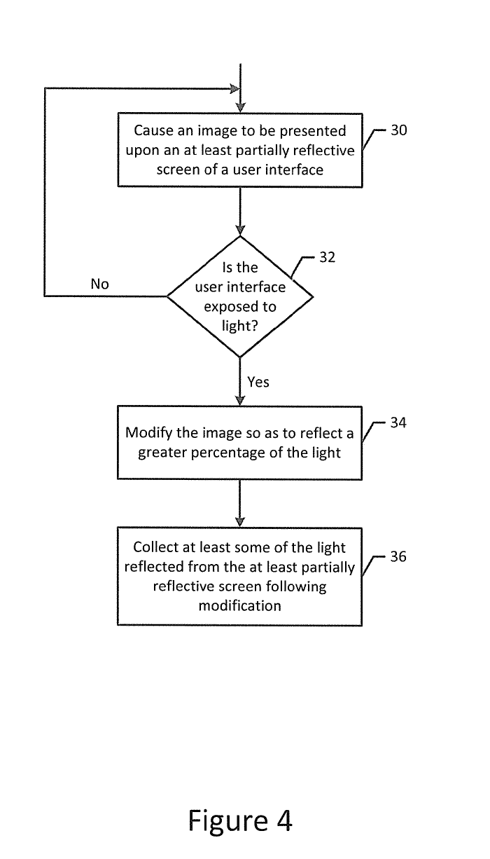

Referring now FIG. 4, the operations performed to modify the image presented by an at least partially reflective screen 14 so as to improve the solar energy collection efficiency in accordance with an example embodiment are depicted. Although generally described hereinafter in conjunction with the modification of the image while the mobile device 10 is active, the method, apparatus 20 and computer program product may be configured to detect exposure to light and to responsively modify the image upon the at least partially reflective screen during other modes, such as during a sleep or power conservation mode, during a screen lock mode and/or while the mobile device is powered off. As shown in block 30 of FIG. 4, the apparatus 20 may include means, such as the processor 22, the user interface 26 or the like, for causing an image to be presented upon the at least partially reflective screen 14 of the user interface. Various types of images may be presented including images that include alphanumeric or other textual information, images that include one or more icons, video images, still images or the like. Additionally, the images that are caused to be presented upon the at least partially reflective screen may be presented in color or may be presented as a gray scale image.

The apparatus 20 may also include means, such as the processor 22 or the like, for determining that the user interface 26 is exposed to light. As described below, the determination that the user interface is exposed to light may trigger a modification of the image presented upon the at least partially reflective screen 14. The apparatus, such as the processor, may determine that the user interface is exposed to light in various manners. For example, the apparatus may include or otherwise be in communication with a light sensor that receives light and provides a signal in response thereto indicative of the presence of light and, in some instances, indicative of the intensity of the light that is incident thereupon. In this example embodiment, the processor may be configured to receive the signal provided by the light sensor and may determine whether that light is incident upon the display in instances in which the signal provided by the light sensor is indicative of the exposure of the light sensor to light.

The apparatus 20, such as the processor 22, may be configured to determine that the user interface 26 is exposed to light by detecting the presence of light or the absence of light, such as indicated by a signal provided by a light sensor. In other embodiments, the apparatus, such as the processor, may be configured to determine that the user interface is exposed to light only in instances in which the processor determines that the user interface is exposed to at least a predefined threshold amount or intensity of light. In this example embodiment, the user interface may be exposed to relatively low levels or low intensity light that is less than the predefined threshold with the processor being configured in such a manner that the user interface is not considered to be exposed to light. However, once the amount or intensity of light that impinges upon the user interface increases to a level that equals or exceeds the predefined threshold, the processor may determine that the user interface is exposed to light so as to trigger modification of the image presented by the at least partially reflected screen 14.

As shown in FIG. 4, in instances in which the user interface 26 is not determined to be exposed to light, the apparatus 20, such as the processor 22, may continue to cause the image to be presented, without modification, upon the at least partially reflective screen 14 of the user interface and may continue to monitor the exposure of the user interface to light. However, in response to a determination that the user interface is exposed to light, such as by being exposed to at least a threshold amount or intensity of light, the apparatus may include means, such as the processor, the user interface or the like, for modifying the image presented upon the at least partially reflective screen so as to reflect and to facilitate collection of a greater percentage of the light than prior to the modification of the image. See block 34 of FIG. 4. The image that is presented upon the at least partially reflective screen may be modified in various manners so as to reflect the greater percentage of the light incident thereupon.

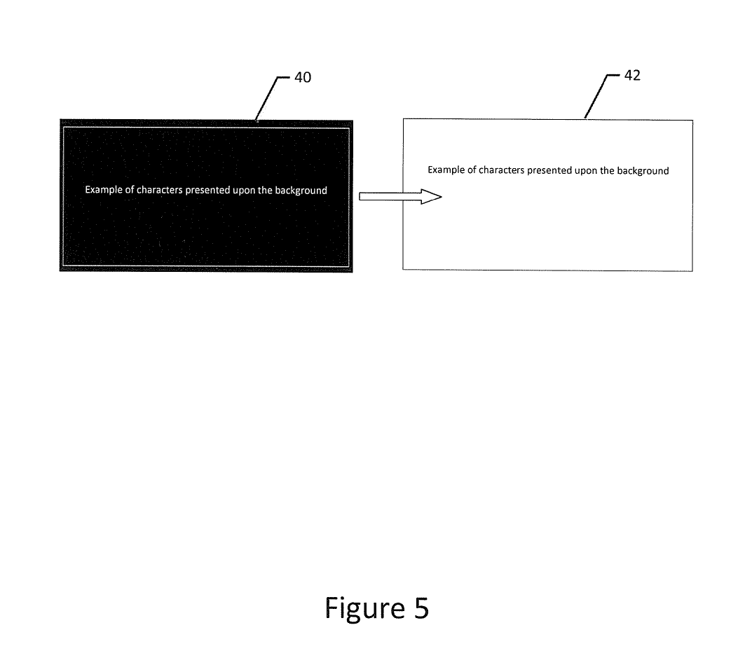

As shown in FIG. 5, for example, the image 40 that is presented upon the at least partially reflective screen 14 prior to a determination that the user interface 26 is exposed to light may include a relatively dark background and relatively light characters presented thereupon. Although illustrated in FIG. 5 as a black background with white characters presented thereupon, the background of the image of this example embodiment may be any color or any gray scale that is darker than the characters presented thereupon. In response to a determination that the user interface is exposed to light, the apparatus 20, such as the processor 22, may be configured to modify the image presented upon the at least partially reflective screen by changing the background of the image to be lighter in color than one or more characters of the image. As shown by image 42 of FIG. 5, following modification, the background of the image may be changed to white with darker characters, such as black characters, presented thereupon. However, the background of the image may be changed to any color that is lighter than the character presented thereupon. Since the background of the image of this example embodiment covers a greater percentage of the screen than the characters presented thereupon, the change of the background to be lighter in color than the characters provides for a greater percentage of the light incident thereupon to be reflected. In other words, in an instance in which the screen includes a plurality of pixels, the apparatus, such as the processor, may be configured to modify the image in response to the exposure of the user interface to light by causing a greater percentage of the pixels to be lighter in color than the image that is presented prior to the determination that the user interface is exposed to light, such as by causing a greater percentage of the pixels to be white.

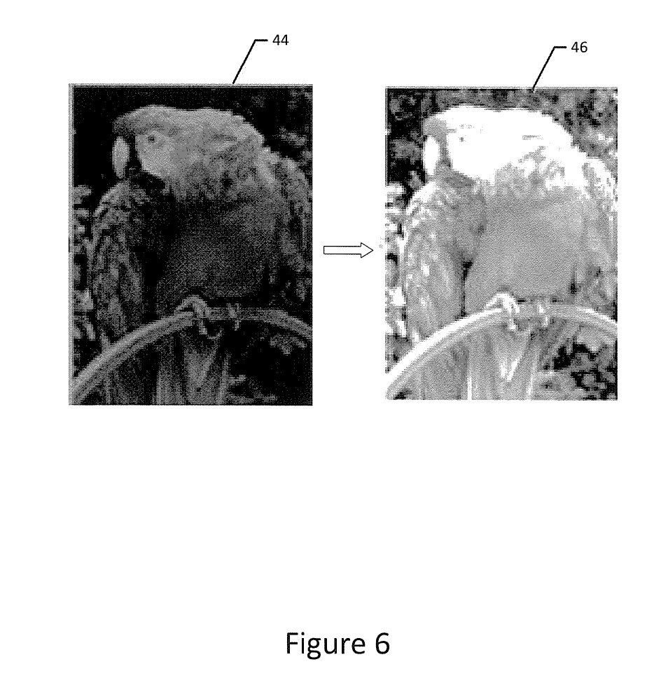

In another example embodiment, the image that is caused to be presented upon the at least partially reflective screen 14 prior to the exposure of the user interface 26 to light is a gray scale image as shown by image 44 of FIG. 6. In this example embodiment, the apparatus 20, such as the processor 22, may be configured to modify the image by causing the gray scale image to be presented with a lighter overall tone following a determination that the user interface is exposed to light. For example, the apparatus, such as the processor, may modify the gray scale image presented by the plurality of pixels of the screen such that at least some of the pixels, e.g., a majority of the pixels or all of the pixels, present the image in a manner that is lighter in tone following the determination that user interface is exposed to light relative to the image that was presented upon the at least partially reflective screen prior to the determination that the user interface is exposed to light. In this regard, an example of a modified gray scale image with a lighter overall tone is shown by image 46 of FIG. 6 relative to the image 44 that is presented prior to the determination that the user interface is exposed to light.

Additionally or alternatively, the apparatus 20, such as the processor 22, may be configured to modify the image presented upon the at least partially reflective screen 14 so as to reflect a greater percentage of the light by causing the image that is presented upon the at least partially reflective screen to have increased stability, that is, to be more stable. By increasing the stability of the image presented upon the at least partially reflective screen, the light that is reflected from the at least partially reflective screen and captured by the solar cells 16 will also similarly be more stable such that the energy provided to the charging circuit, such as in the form of an electrical current, will be more stable which, in turn, will improve the performance of the charging circuit including the recharging of the battery of the mobile device 10. The apparatus, such as the processor, may be configured to increase the stability of the image presented upon the at least partially reflective screen in various manners. For example, the apparatus, such as the processor, may be configured to increase the stability of the image presented upon the at least partially reflective screen by disabling a scrolling function so as to prevent scrolling of the image across the at least partially reflective screen. Alternatively, the apparatus, such as the processor, may be configured to increase the stability of the image, not by completely disabling the scrolling function, but by reducing the speed or rate at which the image may be scrolled. Further, the apparatus, such as the processor, may be configured to increase the stability of the image by preventing or at least slowing the transition of the image presented upon the at least partially reflective screen to a screen saver, by preventing twisted light animation, by ceasing or reducing strobe effects, by preventing or reducing moving text or the like.

As shown in block 36 of FIG. 4, the mobile device 10 and, in one example embodiment, the apparatus 20 may also include means, such as one or more solar cells 16 or the like, for collecting at least some of the light reflected from the at least partially reflective screen 14 following modification. By having modified the image presented upon the at least partially reflective screen so as to reflect a greater percentage of the light following modification than prior to modification, a greater percentage of light is reflected from the at least partially reflective screen and impinges upon the solar cells such that the energy collected by the solar cells and converted to electrical energy so as to, for example, recharge the battery of the mobile device is correspondingly increased. Thus, the efficiency with which solar energy is collected by the mobile device of an example embodiment may be increased, thereby reducing the frequency with which the mobile device must be connected to a wall outlet or other source of electrical power in order to recharge the battery and limiting the instances in which the user finds the mobile device to be without power and therefore at least temporarily inoperable. Further, the method, apparatus and computer program product of an example embodiment may allow for more energy efficient operation of the mobile device as a result of the improved collection efficiency of the solar energy incident thereupon.

As described above, FIG. 4 illustrates a flowchart of an apparatus 20, method and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-20. (canceled)

21. A method comprising:
causing an image to be presented upon an at least partially reflective screen of a user interface;
determining that the user interface is exposed to light; and
in response to a determination that the user interface is exposed to light, modifying the image presented upon the at least partially reflective screen so as to reflect and to facilitate collection of a greater percentage of the light.

22. A method according to claim 21 wherein modifying the image comprises changing a background of the image to be lighter in color than one or more characters of the image.

23. A method according to claim 22 wherein changing the background of the image comprises changing the background of the image to be white.

24. A method according to claim 21 wherein causing the image to be presented comprises causing a gray scale image to be presented, and wherein modifying the image comprises causing the gray scale image to be presented with a lighter overall tone.

25. A method according to claim 21 wherein the screen comprises a plurality of pixels, and wherein modifying the image comprises causing a greater percentage of the pixels to be white.

26. A method according to claim 21 wherein modifying the image comprises causing the image to be modified so as to have increased stability.

27. An apparatus comprising at least one processor and at least one memory including computer program code, the at least one memory and the computer program code configured to, with the processor, cause the apparatus to at least:
cause an image to be presented upon an at least partially reflective screen of a user interface;
determine that the user interface is exposed to light; and
in response to a determination that the user interface is exposed to light, modify the image presented upon the at least partially reflective screen so as to reflect and to facilitate collection of a greater percentage of the light.

28. An apparatus according to claim 27 wherein the at least one memory and the computer program code are configured to, with the processor, cause the apparatus to modify the image by changing a background of the image to be lighter in color than one or more characters of the image.

29. An apparatus according to claim 28 wherein the at least one memory and the computer program code are configured to, with the processor, cause the apparatus to change the background of the image by changing the background of the image to be white.

30. An apparatus according to claim 27 wherein the at least one memory and the computer program code are configured to, with the processor, cause the apparatus to cause the image to be presented by causing a gray scale image to be presented, and wherein the at least one memory and the computer program code are configured to, with the processor, cause the apparatus to modify the image by causing the gray scale image to be presented with a lighter overall tone.

31. An apparatus according to claim 27 wherein the screen comprises a plurality of pixels, and wherein the at least one memory and the computer program code are configured to, with the processor, cause the apparatus to modify the image by causing a greater percentage of the pixels to be white.

32. An apparatus according to claim 27 wherein the at least one memory and the computer program code are configured to, with the processor, cause the apparatus to modify the image by causing the image to be modified so as to have increased stability.

33. An apparatus according to claim 27 wherein the apparatus is embodied by a mobile terminal, and wherein the mobile terminal further comprises the screen and a plurality of photovoltaic cells that at least partially overlie the screen to collect at least some of the light reflected from the at least partially reflective screen following modification.

34. An apparatus according to claim 33 wherein the plurality of photovoltaic cells comprise a plurality of double-sided photovoltaic cells.

35. A computer program product comprising at least one non-transitory computer-readable storage medium having computer-executable program code portions stored therein, the computer-executable program code portions comprising program code instructions for:
causing an image to be presented upon an at least partially reflective screen of a user interface;
determining that the user interface is exposed to light; and
in response to a determination that the user interface is exposed to light, modifying the image presented upon the at least partially reflective screen so as to reflect and to facilitate collection of a greater percentage of the light.

36. A computer program product according to claim 35 wherein the program code instructions for modifying the image comprise program code instructions for changing a background of the image to be lighter in color than one or more characters of the image.

37. A computer program product according to claim 36 wherein the program code instructions for changing the background of the image comprise program code instructions for changing the background of the image to be white.

38. A computer program product according to claim 35 wherein the program code instructions for causing the image to be presented comprise program code instructions for causing a gray scale image to be presented, and wherein the program code instructions for modifying the image comprise program code instructions for causing the gray scale image to be presented with a lighter overall tone.

39. A computer program product according to claim 35 wherein the screen comprises a plurality of pixels, and wherein the program code instructions for modifying the image comprise program code instructions for causing a greater percentage of the pixels to be white.

40. A computer program product according to claim 35 wherein the program code instructions for modifying the image comprise program code instructions for causing the image to be modified so as to have increased stability.
